(19) United States
(12) Patent Application Publication
(10) Pub. No.: US 2007/0162181 A1
(43) Pub. Date: Jul. 12, 2007

(54) IMAGE DISPLAY SYSTEM

(75) Inventor: Hiroyuki Ichieda, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/610,054

(22) Filed: Dec. 13, 2006

(30) Foreign Application Priority Data
Jan. 10, 2006 (JP) 2006-002794

(51) Int. Cl. G06F 7/00; G06F 17/00; G05B 19/00; G06F 15/177

(52) U.S. Cl. 700/225; 235/375; 709/220; 340/5.61

(57) ABSTRACT

An image display system includes a projector having an RFID tag section and a first wireless LAN section whose network setting is automatically performed, and a wireless terminal including an RFID reading device and a second wireless LAN section, wherein the image display system transmits RFID tag information including information for performing network setting to the wireless terminal in response to the RFID tag section receiving an electronic wave emitted by the RFID reading device of the wireless terminal, and the wireless terminal, in response to the RFID reading device receiving the RFID tag information, automatically performs the network setting to the second wireless LAN section based on the RFID tag information, and makes the second wireless LAN section transmit a predetermined content to the first wireless LAN section.

### BACKGROUND

1. Technical Field

The present invention relates to an image display system provided with a projector, and in particular to a network connection between the projector and a wireless terminal.

2. Related Art

In the past, as an image display system utilizing a projector, there has been proposed a display system for advertisement use such as delivering contents via a network, and displaying them with a projector (see JP-A-2005-167573). In the system, the user is required to perform network setting of each of the devices for establishing a network between the projector and a server.

However, it is a very troublesome work for the user who does not have enough knowledge about the network to perform network setting to each of the devices for establishing communication.

### SUMMARY

In view of the problems described above, some aspects of the invention have an advantage of providing an image display system capable of automatically performing the network setting.

According to an aspect of the invention, there is provided an image display system including a projector including an RFID tag section and a first wireless LAN section whose network setting is automatically performed, and a wireless terminal including an RFID reading device and a second wireless LAN section. In the image display system, the image display system transmits RFID tag information including information for performing network setting to the wireless terminal in response to the RFID tag section receiving an electronic wave emitted by the RFID reading device of the wireless terminal, and the wireless terminal, in response to the RFID reading device receiving the RFID tag information, automatically performs the network setting to the second wireless LAN section based on the RFID tag information, and makes the second wireless LAN section transmit a predetermined content to the first wireless LAN section. In this aspect of the invention, by locating the projector provided with the RFID tag section in a range in which it can receive the radio wave emitted by the RFID reading device, the network settings are performed on the second wireless LAN section of the wireless terminal, thus the communication between the projector and the wireless terminal is automatically established. Therefore, the user can be released from the troublesome manual network settings performed in the past. Further, this becomes particularly effective for the user who has little knowledge about the network technology. As described above, since there is no need for manually performing the network settings of the projector and the wireless terminal, the operation for making the projector display the contents of the wireless terminal side becomes easy.

Further, according to another aspect of the invention, there is provided an image display system wherein the projector receives the content from the wireless terminal by the first wireless LAN section to display the content. In this aspect of the invention, since there is no need for manually performing the network settings of the wireless terminal, the operation for displaying the content of the wireless terminal becomes easy.

Further, according to another aspect of the invention, there is provided an image display system wherein the projector and the wireless terminal are connected to each other in the ad-hoc mode. Since in this aspect of the invention they are wireless-connected to each other in the ad-hoc mode without transiting an access point, the transmission rate of the content becomes faster.

Further, according to another aspect of the invention, there is provided an image display system wherein the RFID tag section transmits, as the RFID tag information, information of a projector identifier, a connection type, and a connection parameter. In this aspect of the invention, it becomes possible to automatically perform the network setting in the wireless terminal based on the above information, and also to perform setting in accordance with the model of the projector.

Further, according to another aspect of the invention, there is provided an image display system wherein the RFID tag section further transmits, as the RFID tag information, information of the content and a play type. In this aspect of the invention, since the content is transmitted by transmitting such information, the trouble of performing setting for playing the content after the communication has established can be saved.

Further, according to another aspect of the invention, there is provided an image display system wherein the wireless terminal, when the reading device receives the RFID tag information while already connected to another projector, disconnects the connection with the another projector, and establishes wireless connection with a projector that newly transmits the RFID tag information. In this aspect of the invention, when they are wireless-connected to each other in the ad-hoc mode, if plural projectors compete against each other to a single wireless terminal, the connection with a newly implemented projector is provided with precedence to avoid any confusion.

### BRIEF DESCRIPTION OF THE DRAWINGS

The invention will now be described with reference to the accompanying drawings, wherein like numbers refer to like elements.

FIG. 1 is a configuration diagram of an image display system according to a first embodiment of the invention

FIG. 2 is a block diagram showing details of a projector and a personal computer.

FIG. 3 is a block diagram showing a configuration of an RFID tag section.

FIG. 4 is a flowchart showing an action of the image display system described above.

FIG. 5 is a flowchart showing an action of a personal computer according to a second embodiment of the invention.

### DESCRIPTION OF EXEMPLARY EMBODIMENTS

### First Embodiment

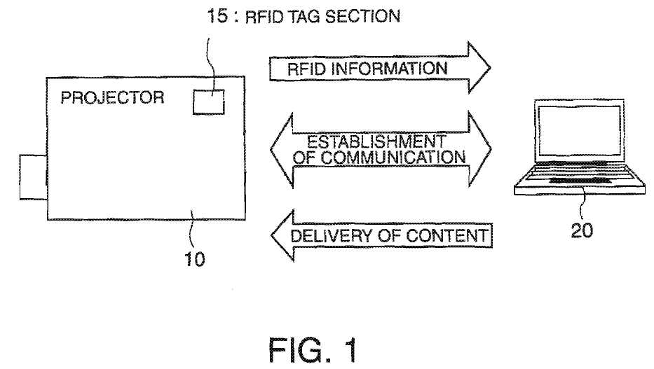

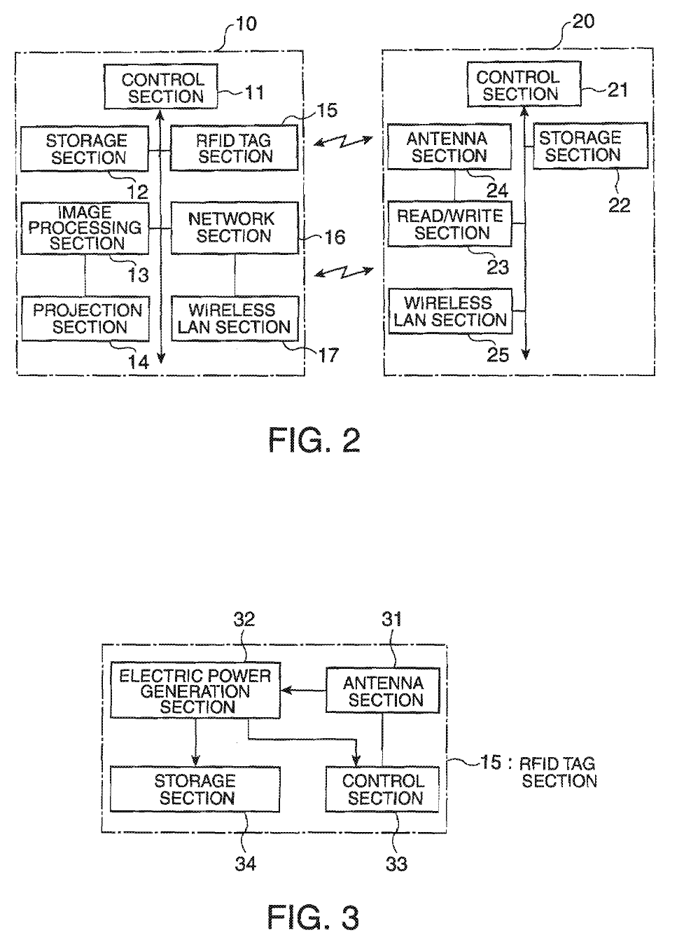

FIG. 1 is a configuration diagram of an image display system according to a first embodiment of the invention, and FIG. 2 is a block diagram showing details of a projector 10 and a personal computer 20 composing the image display system. It should be noted that FIG. 2 shows only parts extracted from the projector 10 and the personal computer 20, which are necessary for explanations. The projector 10 is mainly composed of a control section 11, storage section 12, an image processing section 13, a projection section 14, a radio frequency identification (RFID) tag section 15, a network section 16, and a wireless LAN section 17. The personal computer 20 is mainly composed of a control section 21, a storage section 22, a read/write section 23, an antenna section 24, and a wireless LAN section 25. The control section 11 of the projector 10 and the control section 21 of the personal computer 20 are each mainly composed of a CPU and a storage device storing a program for making the CPU perform arithmetic processing (neither shown). Further, the read/write section 23 and the antenna section 24 of the personal computer 20 are for communicating data with the RFID tag section 15 of the projector 10, and in response to receiving, for example, a radio wave from the RFID tag section 15 of the projector 10 via the antenna section 24, the read/write section 23 demodulates it to acquire data, or when sending data to the RFID tag section 15, it modulates the relevant data and transmits it via the antenna section 24. Further, the storage section 22 stores a content (e.g., an MPEG file) to be displayed by the projector 10. It should be noted that the read/write section 23 corresponds to an RFID reading device of the invention.

FIG. 3 is a block diagram showing a configuration of the RFID tag section 15. The RFID tag section 15 is mainly composed of an antenna section 31, an electric power generation section 32, a control section 33, and a storage section 34. The electric power generation section 32 is composed of, for example, a capacitor and a rectification circuit, and generates the electric power from the radio wave transmitted from the read/write section 23 of the personal computer 20 via the antenna 24 in response to the antenna section 31 receiving the radio wave to supply it to the control section 33 and the storage section 34 as the drive power. The control section 33 is provided with a modulator circuit, a demodulator circuit, and so on embedded therein, and demodulates the radio wave received by the antenna section 31 to retrieve the data therefrom and store it in the storage section 34, or modulates the data stored in the storage section 34 to transmit it via the antenna section 31. Further, the storage section 34 stores the following information (RFID tag information).

Projector identifier: model name

Connection type: wireless LAN

Connection parameter: private IP, subnet mask, service set ID (SSID)

Playlist: content name list or content path list

Play mode: number of times, repeat and/or time point

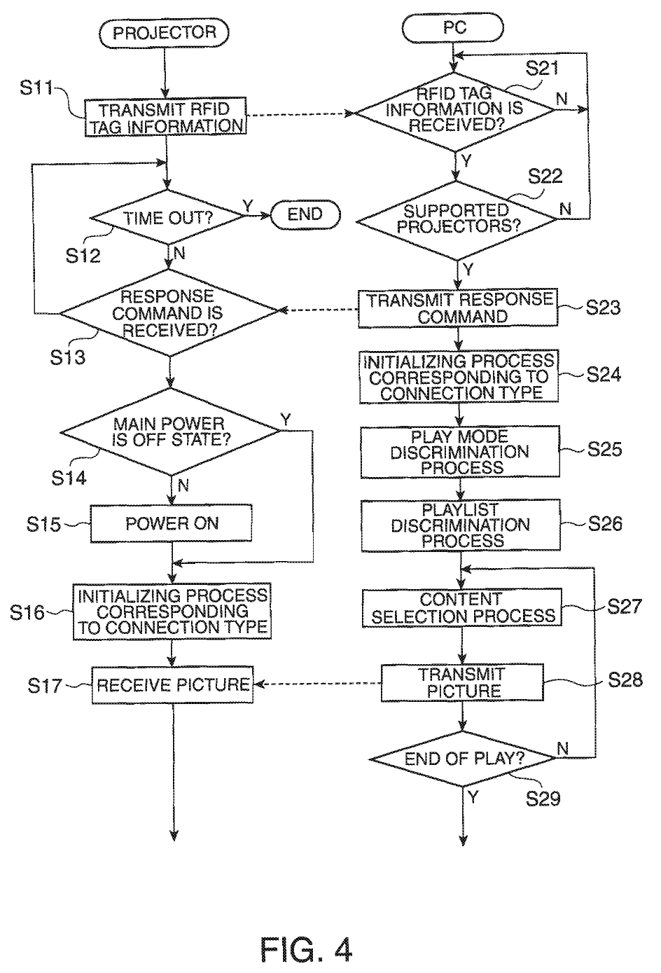

FIG. 4 is a flowchart showing an action of the image display system described above, and the action will now be explained with reference to the drawing.

In response to receiving the radio wave from the read/write section 23 and the antenna section 24 of the personal computer 20, the RFID tag section 15 of the projector 10 retrieves the RFID tag information stored in the storage section 34 and transmit it (S11). In response to the read/write section 23 receiving the RFID tag information (S21), the control section 21 of the personal computer 20 judges from the RFID tag information whether or not the projector is one the personal computer 20 supports (S22). If the projector is not the one the personal computer 20 supports, the control section 21 watches further reception of the RFID tag information. When the control section 21 has judged from the RFID tag information that the projector is the supported one, the control section 21 instructs the read/write section 23 to transmit a response command via the antenna section 24 the personal computer (S23). The control section 21 performs an initialization process in accordance with the connection type (S24). In this example, since the connection type is a wireless LAN, the network setting is performed based on connection parameters (the private IP, the subnet mask, and the SSID) from the RFID tag information to establish communication in the ad-hoc mode.

The control section 11 of the projector 10 judges whether or not it received the response command from the personal computer 20 in a predetermined period of time after the transmission of the RFID tag information (S12, S13). It should be noted that the control section 11 receives the response command via the RFID tag section 15. When the control section 11 judges that it received the response command from the personal computer 20 in the predetermined time period, it further judges whether or not the main power (not shown) is in an OFF state (S14), and if it is in the OFF state, it switches ON the main power (S15). Then, it performs the initialization process corresponding to the connection type (S16). In this case, since the connection type is the wireless LAN, the process corresponding thereto is to be performed.

After establishing the communication in the ad-hoc mode, the control section 21 of the personal computer 20 discriminates the play mode in the RFID tag information to perform setting in accordance with the mode (S26), and subsequently, discriminates the playlist to select the content to be played from the storage section 22 (S27). Then, it transmits the content to the projector 10 side in a streaming manner via the wireless LAN section 25 (S29). It repeats the transmission of the content in accordance with the play mode described above, and terminates it in response to an instruction for termination (S30).

When the wireless LAN section 17 of the projector 10 receives the content transmitted from the wireless LAN section 25 of the personal computer 20, the image processing section 13 decodes the received content to make the projection section 14 display the picture of the content on the screen (S17).

As described above, in the first embodiment, by locating the projector 10 provided with the RFID tag section 15 in a range in which it can receive the radio wave emitted by the read/write section (RFID reading device) 23, the network settings are performed on the wireless LAN section 25 of the personal computer 20, thus the communication between the projector 10 and the personal computer 20 is automatically established. Therefore, the user can be released from the troublesome manual network settings performed in the past. Further, this is particularly effective for the user who has little knowledge about the network technology. As described above, since there is no need for manually performing the network settings of the projector 10 and the personal computer 20, the operation for making the projector 10 display the contents of the personal computer 20 becomes easy.

Further, since the projector 10 and the personal computer 20 are wireless-connected to each other in the ad-hoc mode without transiting an access point, the transmission rate of the content becomes faster. Further, the RFID tag section 15 transmits information such as the projector identifier, the connection type, and the connection parameters as the RFID tag information. The personal computer 20 allows the automatic network setting based on the information, and also performs setting in accordance with the model type of the projector 10. Moreover, the RFID tag section 15 further transmits the information of the content and the play type as the RFID tag information, and accordingly, the trouble of performing setting for playing the content after the communication has established can be saved. In particular, since the projector 10 is not provided with input means such as a keyboard, it is effective in the actual handling of the equipment that the trouble of performing setting for playing the content can be saved.

### Second Embodiment

In the first embodiment, an example of establishing the net connection with the wireless LAN between one projector 10 and one personal computer 20 is explained. As a second embodiment, the action in the case in which the personal computer 20 is supposedly connected to a certain projector 10 (the projector is referred to as a projector A) and another projector (referred to as a projector B) is further implemented will be explained.

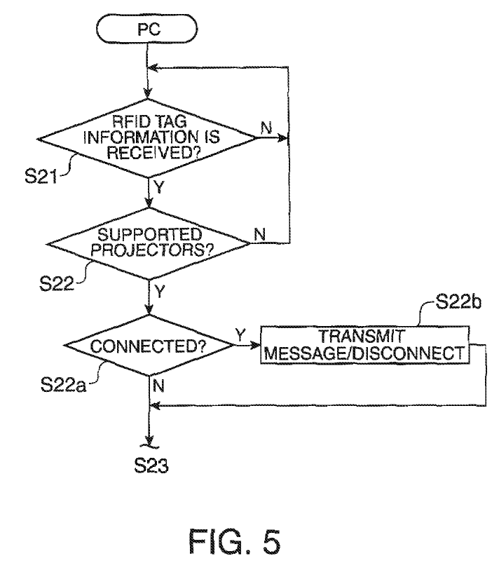

FIG. 5 is a flowchart showing the action of the personal computer 20 in the second embodiment, which is illustrated focusing on the differences from FIG. 4. When the control section 21 of the personal computer 20 receives the RFID tag information of the projector B (S21), and then it is judged from the RFID tag information that the projector B is supported by the personal computer 20 (S22), if there is subsequently a condition of already connecting to the projector A, the control section 21 transmits a message to the projector A that it disconnects the projector A, and then disconnects it, and after then, it proceeds to a process of connecting with the projector B.

As described above, in the second embodiment, when they are wireless-connected to each other in the ad-hoc mode, if plural projectors compete against each other to a single personal computer, the connection with a newly implemented projector is provided with precedence to avoid any confusion

### Third Embodiment

Further, although an example of personal computer 20 as the wireless terminal is explained in the first embodiment, the personal computer 20 can be either of the server or the client, and it can be configured to be connected to a database storing the content and to read the content therefrom. Further, the wireless terminal is not limited to the personal computer 20, but can be other equipment providing that the wireless LAN can be established therewith. Further, although the example of the ad-hoc mode is explained as an example of the wireless connection, the connection in the infrastructure mode can also be adopted.

The entire disclosure of Japanese Patent Application No. 2006-002794, filed Jan. 10, 2006 is expressly incorporated by reference herein.

What is claimed is:

1. An image display system comprising:
a projector including an RFID tag section and a first wireless LAN section whose network setting is automatically performed; and
a wireless terminal including an RFID reading device and a second wireless LAN section;
wherein
the image display system transmits RFID tag information including information for performing network setting to the wireless terminal in response to the RFID tag section receiving an electronic wave emitted by the RFID reading device of the wireless terminal, and
the wireless terminal, in response to the RFID reading device receiving the RFID tag information, automatically performs the network setting to the second wireless LAN section based on the RFID tag information, and makes the second wireless LAN section transmit a predetermined content to the first wireless LAN section.

2. The image display system according to claim 1,
wherein the projector receives the content from the wireless terminal by the first wireless LAN section to display the content.

3. The image display system according to claim 1,
wherein the projector and the wireless terminal are connected to each other in an ad-hoc mode.

4. The image display system according to claim 1,
wherein the RFID tag section transmits, as the RFID tag information, information of a projector identifier, a connection type, and a connection parameter.

5. The image display system according to claim 4,
wherein the RFID tag section further transmits information regarding the content and a play type as the RFID tag information.

6. The image display system according to claim 5,
wherein the wireless terminal transmits the content in accordance with the information of the content and the play type.

7. The image display system according to claim 1,
wherein the wireless terminal, when the RFID reading device receives the RFID tag information while already connected to another projector, disconnects the connection with the another projector, and establishes wireless connection with a projector that newly transmits the RFID tag information.
